(19) United States
(12) Patent Application Publication
(10) Pub. No.: US 2013/0103420 A1
(43) Pub. Date: Apr. 25, 2013

(54) SYSTEM AND METHOD FACILITATING PATIENT REGISTRATION ACROSS MULTIPLE PRACTICE GROUPS

(71) Applicants: Cyrus E. Massoumi, New York, NY (US); Oliver D. Kharraz Tavakol, Brooklyn, NY (US)

(72) Inventors: Cyrus E. Massoumi, New York, NY (US); Oliver D. Kharraz Tavakol, Brooklyn, NY (US)

(73) Assignee: ZocDoc, Inc., New York, NY (US)

(21) Appl. No.: 13/279,683

(22) Filed: Oct. 24, 2011

(51) Int. Cl. G06Q 50/24

(52) U.S. Cl. 705/3

(57) ABSTRACT

System and method for the gathering of patient information and completion of patient information forms across multiple practice groups. An aggregator utilizes the patient information forms provided by different groups to create marked-up forms and a library of questions. The aggregator can then present ordered sets of questions from the library to a patient to obtain patient information for responding to the requests in one or more forms.

### FIELD OF THE INVENTION

The present invention relates to the gathering of patient information that typically occurs prior to an appointment with a medical practitioner, e.g., patient registration, and more particularly to a system and method to facilitate such registration across multiple practice groups.

### BACKGROUND

Patient information forms are an essential part of each medical practice group for many reasons, including for example: obtaining permission to administer treatment and perform procedures as may be deemed necessary in the diagnosis and/or treatment of the patient's condition; soliciting information from the patient concerning his/her current physical condition and reason for the visit: gathering past medical history, for which the patient may have been treated by other provider groups; gathering information on the medical history of the patient's relatives (e.g., parents, siblings) that may relate to the diagnosis of the patient's current condition; identification of the patient's current insurance company, plan and primary subscriber; authorization to release information to the patient's insurance carrier; emergency contact information; personal contact information; and responsibility for payment of charges incurred by the practitioner in treating the patient. There is no universally accepted set of the patient information forms. Individual practice groups offer their own forms, and decide which forms to utilize with individual patients having different types of appointments. The patient information forms may also be tied to the individual practice group's computerized systems for medical record keeping, billing, insurance collection, appointment scheduling, etc.

The breath and complexity of the forms and patient information sought, elicits a significant cost on both the practitioner and patient. Typically, the patient is asked to arrive early to complete the forms prior to the appointment. This may or may not be successful, as patients often resist requests for early arrival, particularly when they are taking time off from work to attend the appointment. As a result, the time spent filling out forms often delays the start of the appointment and creates a cascading backlog of lost time, i.e., with physicians waiting for and being unable to examine the next patient and patients waiting longer and longer in the waiting room for their scheduled appointments. Some practice groups having tried mailing or emailing the forms to their patients prior to the visit, but the return rate of completed forms is relatively low. Also patients become annoyed that they are repeatedly being asked to enter the same information.

A system is needed to facilitate this process of gathering patient information which appeals to both the patient and the practice groups so that both parties readily participate in and gain from utilizing the new process.

### SUMMARY OF THE INVENTION

According to one embodiment of the invention, a system and method are provided that facilitates gathering of patient information and completion of patient information forms across multiple practice groups. An aggregator utilizes the patient information forms provided by different groups to create marked-up forms and creates a library of questions based on information requested in the practice group forms. The aggregator can then present ordered sets of questions from the library to solicit from a patient relevant patient information for responding to requests in one or more forms.

In one embodiment, the aggregator obtains or creates a digital image (e.g., scan) of each patient information form and identifies the locations of entry areas (e.g., blanks, multiple-choice answers) on the form that request patient answers. The aggregator associates each entry area with a location identifier (that defines a physical location of that area on the form) and with at least one question (from the library of questions) for soliciting patient information relevant to the entry area.

In one embodiment, the aggregator enlists a human operator to visually identify the physical locations of the entry areas on the practice group forms that request patient answers. The operator then manually associates each entry area with at least one question, from the library of questions, for soliciting patient information relevant to the entry area.

If another embodiment, the aggregator enlists a computer program application that automatically performs the steps of identifying entry areas in the practice group forms and selecting a question from the question library to be associated with each entry area, thus enabling the automatic creation of marked-up forms electronically (by an application) rather than requiring the assistance of a human operator. The application may utilize character recognition, similarity or exact matching searches and/or rule based logic for associating each entry area in the practice group form to an associated question in the aggregator's question library.

In another embodiment, the aggregator populates the marked-up forms utilizing patient information solicited prior to an appointment and/or otherwise available to the aggregator. In one example, the aggregator also provides an online medical appointment booking service and prompts the user after booking to complete one or more forms relevant to the scheduled appointment. The aggregator may have previously acquired (e.g., stored) some patient information based on registration of the patient with the aggregator's booking service. This information can be utilized in populating the form without asking the patient for this information. Additional information may be required which the aggregator will then present to the patient as a series of ordered questions that facilitate the gathering of the required information in a manner that can be utilized for completing forms from a range of different practice groups and/or that minimizes the time required for the patient to provide the necessary information. The patient may be asked to verify the information added to the partially or fully populated form, one or more times during the process, prior to submission of the form(s) to the designated practice group(s).

In accordance with one embodiment of the invention, a computer-implemented method is provided including:
storing a plurality of marked-up patient information forms (PIFs) for a plurality of different practice groups, each marked-up PIF having a plurality of entry areas requesting patient information and each entry area having a question identifier of an associated question from a stored library of patient information questions;
displaying to a patient an ordered set of associated questions from the library for a marked-up PIF and soliciting responses from the patient to the questions; and
receiving one or more responses from the patient to the questions and associating each response with an entry area of the marked-up PIF.

In one embodiment, the method includes generating a partially or fully populated PIF from one of the marked-up PIFs by inserting the one or more patient responses in the entry area(s) having the associated question identifier(s).

In another embodiment, the method includes displaying to the patient a partially or fully populated PIF for editing and/or approval.

In another embodiment, the method includes sending the partially or fully populated PIF to one or more of the practice groups.

In another embodiment, the displaying step occurs after the patient has booked an appointment with the practice group.

In another embodiment, the questions include relationships between the questions.

In one embodiment, the relationships include a hierarchical relationship.

In another embodiment, the hierarchical relationship includes categories of patient information.

In another embodiment, the categories include one or more of medical history information, insurance information, basic information, demographic information, contact information, and family information.

In another embodiment, the method includes generating the ordered set of questions using a rules set for determining a presentation order of the associated questions in the set.

In one embodiment, the rules set includes one or more of question expiration, question succession, question inheritance, question duplication, question concatenation, and question omission.

In another embodiment, the method includes generating the marked-up PIFs by displaying a visual image of a patient information form to a human operator and soliciting from the operator the question identifier for the entry area on the patient information form.

In another embodiment, the method includes generating the marked-up PIFs with a computer program application which designates the question identifier for the entry area.

In one embodiment, the method includes collecting a plurality of patient information forms from the different practice groups;
generating the plurality of marked-up patient information forms for the collected forms, including designating the question identifier for the entry area.

In accordance with another embodiment of the invention, a computer implemented method is provided which includes, for each of a plurality of information forms (PIFs) from a plurality of practice groups:
identifying each entry area of the PIF that requests a patient answer; associating each entry area with:
   a location identifier defining a physical location of the entry area on the PIF;
   a question identifier of an associated question from a library of questions for soliciting patient information applicable to the plurality of PIFs from the plurality of practice groups.

In another embodiment, the method includes displaying to a patient an ordered set of associated questions from the library for a PIF and soliciting responses from the patient to the questions.

In another embodiment, the method includes receiving one or more responses from the patient to the questions and associating each response with a location identifier.

In accordance with another embodiment of the invention, a computer-readable medium is provided having stored thereon instructions which perform, when loaded into a computer, the steps of:
selecting a category of patient information;
selecting a set of ordered questions, related to the category, from a library of questions for soliciting patient information applicable to one or more of a plurality of patient information forms (PIFs) from a plurality of practice groups;
presenting the set of ordered questions to a patient;
receiving from the patient one or more responses to the questions presented;
associating each response with at least one of the questions presented.

In accordance with another embodiment of the invention, in a computing environment, an apparatus is provided including:
a question manager component operable to generate an ordered set of questions from a stored library of patient information questions, the question manager including a rule based logic for determining a presentation order of the questions in the set; and
a display manager component operable to present the ordered set of questions to a patient and solicit responses to the questions from the patient.

In another embodiment, the apparatus includes:
a forms manager component operable to generate marked-up patient information forms for each of a plurality of practice groups, each marked-up form having one or more entry areas, each entry area having an associated question from the library of questions, and for populating the entry area of the patient information form with a patient response.

These and other embodiments of the invention will be more fully understood with regards to the following detailed description and accompanying drawings.

### BRIEF DESCRIPTION OF THE DRAWINGS

FIG. 1 is a high level block diagram of a patient registration system and method, illustrating communications between patients and an aggregator, and communications between multiple practice groups and the aggregator, according to one embodiment of the invention;

FIG. 2 is a flow chart of a process of creating marked-up patient information forms according to one embodiment of the invention;

FIG. 3 is a flow chart of a process of populating patient information forms according to another embodiment of the invention;

FIG. 4 is a flow chart of a process of completing patient information forms according to another embodiment of the invention;

FIG. 5 is a flow chart of a process of requesting patient information according to another embodiment of the invention;

FIG. 6 illustrates one embodiment of a database schema for storing data and metadata for marking-up patient information forms according to one embodiment of the invention;

FIG. 7 is one example of a patient information form from a practice group;

FIGS. 8A-8C are screenshots illustrating a user interface of a form mark-up tool application according to one embodiment of the invention, FIG. 8A showing a form on the screen being marked-up by a human operator, FIG. 8B showing a screen allowing an operator to create a new question, and FIG. 8C showing a screen with two alternative marked-up forms for selection and final approval by an operator of one marked-up form;

FIGS. 9A-9G are a series of screenshots illustrating a process enabling a patient to enter relevant patient information after booking an appointment, which information can be used to complete or partially complete the required forms for the appointment;

FIG. 10 is a general network communications and computing environment according to one embodiment of the invention; and

FIG. 11 is a schematic block diagram of an aggregator server according to one embodiment of the invention.

### DETAILED DESCRIPTION

Various embodiments of the present invention are now described with reference to the drawings. In the following description, for purposes of explanation, numerous specific details are set forth in order to provide a thorough understanding of one or more implementations of the present invention. It will be evident, however, that the present invention may be practiced without these specific details. In other instances, well-known structures and devices are shown in block diagram form in order to facilitate describing the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The present invention may also be illustrated as a flow chart of a process of the invention. While, for the purposes of simplicity of explanation, the one or more methodologies shown in the form of a flow chart are described as a series of acts, it is to be understood and appreciated that the present invention is not limited by the order of acts, as some acts may, in accordance with the present invention, occur in a different order and/or concurrent with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

In various embodiments of the invention disclosed herein, the term “physician”, “doctor” or “provider” is used to identify a physician or other healthcare provider administering patient care, as well as members of his/her staff that assist in providing such care or are responsible for maintaining the provider's scheduling calendar and/or patient records.

Further, a “practice group” or “provider group” may be any entity linking a group of providers through shared facilities, services or referral agreements. This may include but should not be limited to integrated multi-facility hospitals, insurance networks, medical groups and multi-doctor practices.

As used herein “patient” means an existing patient, or a prospective (potential new) patient, of a healthcare provider, physician or practice group.

In one or more embodiments of the invention described herein, an “aggregator” is a centralized service provider that provides a wired or wireless network based service to the practice groups (e.g., physician groups, hospitals, clinics) and multiple patients. For example, an aggregator server may provide an application or web-based data processing service and interface to a computer, server, or other wired or wireless communication device (e.g., cell phone, tablet computer, etc.) of the one or more practice groups, healthcare providers and patients.

A. System Architecture

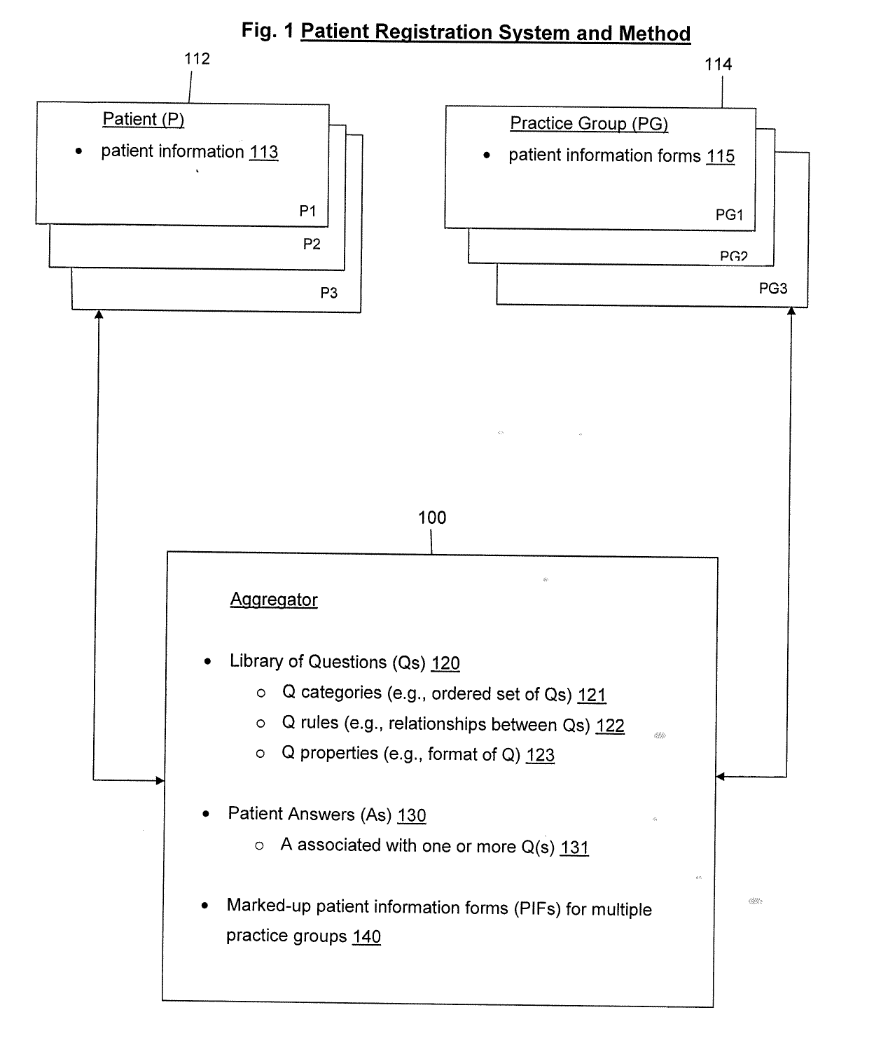

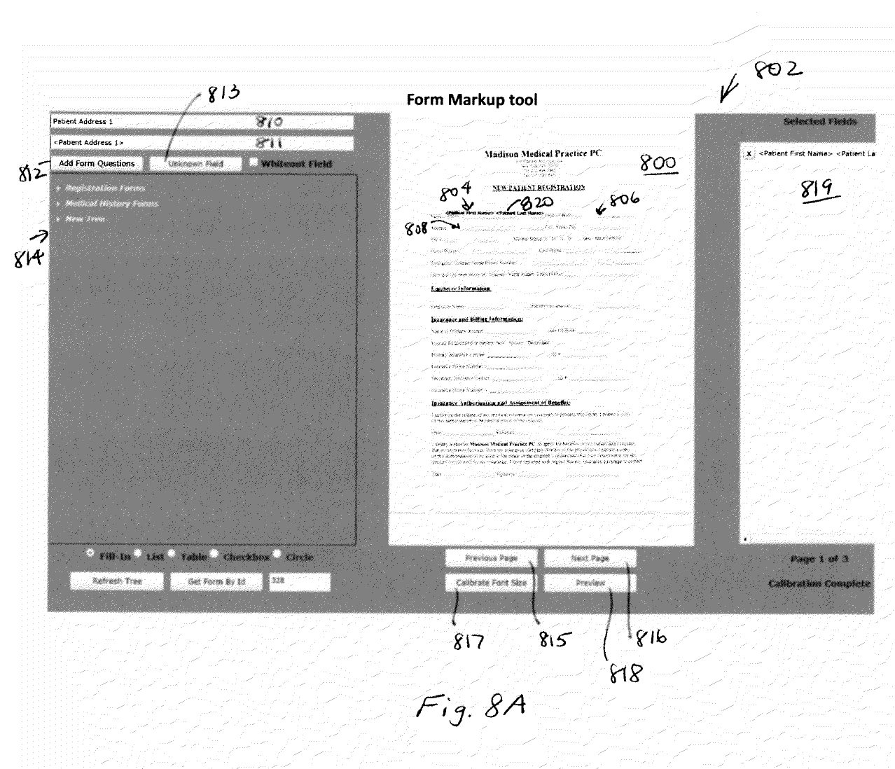

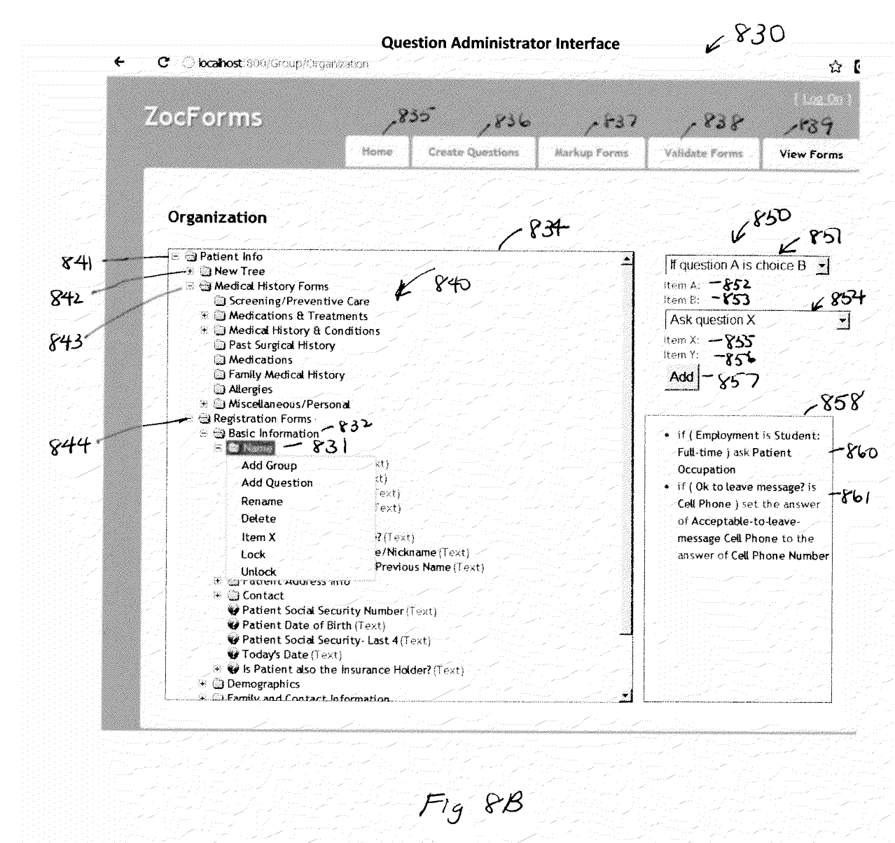

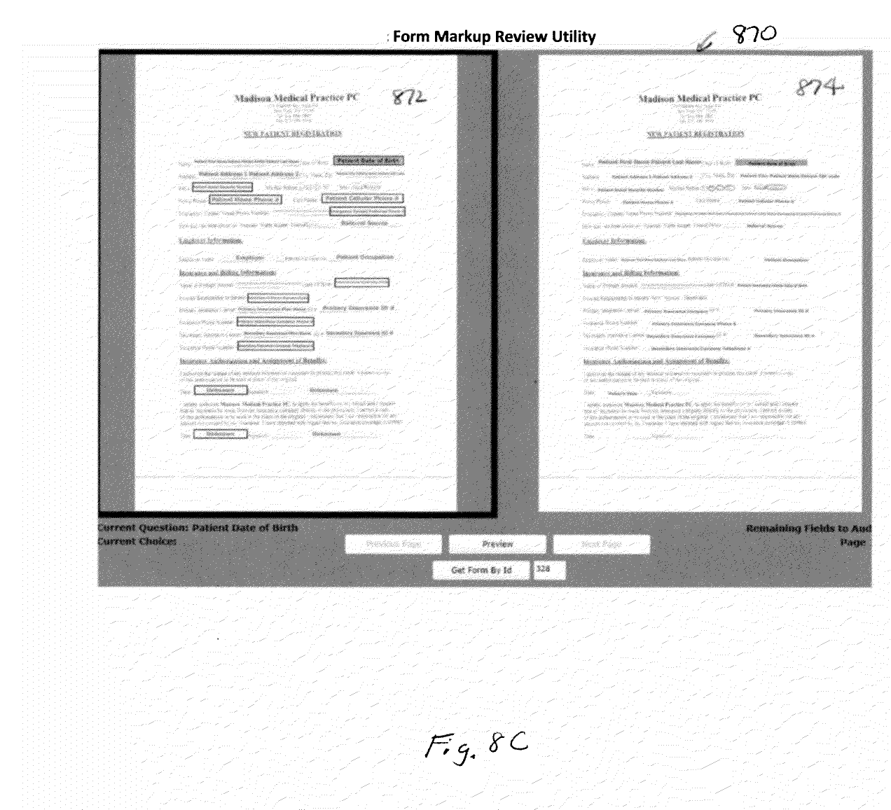

FIG. 1 illustrates a high level system architecture for one embodiment of a patient registration system and method according to the invention. In this embodiment, an aggregator 100 communicates with each of a plurality of patients 112 (P1, P2, P3 . . . ) and each of a plurality of practice groups 114 (PG1, PG2, PG3 . . . ), to facilitate the gathering of patient information 113 from the patients and for the completion or partial completion of patient information forms 115 for the respective practice groups (also referred to a practice group form(s)). The aggregator utilizes a library of questions 120 for soliciting patient information from the patients. As used herein, “library” means an electronically stored collection of questions (including question components) that can be used to assemble a plurality of different sets of ordered questions for presenting to a patient for completion (or partial completion) of one or more patient information forms. For example, the questions can be extracted from the library based upon a specific category of patient information that is required, based upon a specific practice group, and/or based upon a particular subset of the patient information forms for one or more practice groups. In one example, the question categories may include medical history forms, registration forms, demographics and family information, and insurance information. Within each of these question categories 121, there may be subcategories (a hierarchical relationship), e.g., the medical history form parent category may include as subcategories screening/preventive care, medications and treatments, medical history and conditions, etc. The registration form category may include subcategories such as basic information, patient address information and contact information. The subcategories may include further subcategories, etc. An example of a hierarchical collection of questions is illustrated in FIG. 8B and discussed below.

To create an ordered set of questions for a particular category, question rules (logic) 122 are provided that determine relationships between the individual questions. For example, the question rules may relate to expiration (e.g., the patient answer may change over time), inheritance (e.g., if the patient answers yes to question A, then the answer to question B is automatically yes as well), duplication (e.g., if a patient is asked how many siblings they have and they answer more than one, then subsequent questions will be asked about each sibling), concatenation (e.g., an answer to a entry area on a form can be the sum of the answers of multiple questions), and omission (e.g., certain questions can be skipped and marked with a label to indicate that the patient should fill them in after the partially completed form is printed). These and other examples of patient rules are described below; other examples will be apparent to those skilled in the art and are intended to be included within the scope of the present invention. As a result of these rules, an interactive questionnaire is provided to the patient for gathering patient information, wherein the questions and answers map to different practice group forms and requests for information (entry areas) on such forms.

The questions may also have properties 123, e.g., metadata which relates to the format of the question and/or answer. For example, a question may have one or more input types such as: auto-answer, free-text, single-select, multi-select, restricted text (e.g., dates, phone numbers, emails, etc.). The question may have one or multiple output types, for example: free-text, check, circle and underline. For example, a question with an input type multi-select may include in the question multiple boxes each associated with different text, wherein the patient is expected to select (check) zero, one or more of the boxes as a response (output type). Alternatively, the question may provide multiple options as separate text with instructions to the user to circle one or more applicable text portions (rather than check boxes). These and other examples of question properties are described below; other alternatives will be apparent to the skilled person and are intended to be included in the subject matter of the present invention.

The aggregator creates and utilizes a plurality of marked-up patient forms 140, each marked-up form being correlated to an associated practice group form. In one example, the forms are collected from various practice groups, stored and processed as an image or converted (e.g., via optical character recognition) from an image into searchable data or text and then individually marked-up with an application tool, with or without assistance of a human operator. In one embodiment, an interactive computer user interface enables a human operator to use a tool (application) to visually identify (locate) the different entry areas of the form that each request patient information, and then associate each entry area with a question from the library of questions, which questions can then be used to solicit one or more appropriate answers from the patient for completing the entry area(s). The patient's response is transformed (mapped) to an appropriate format (e.g., check mark, yes, text) prior to being inserted as a patient answer at the designated entry area of the form. As a result of the marking process, each practice group form is translated into a template of questions (from the question library), and the patient responses to the questions are inserted in the form entry areas in an appropriate format. By utilizing this rule based set of questions, a more efficient form and order of questions can be provided to the patient for each category of patient information.

As previously described, the aggregator utilizes an ordered set of questions for soliciting patient responses 130 that can then be transformed into patient answers 131 for completing one or more entry areas on one or more patient information forms. In this manner, the aggregator can populate the patient information form(s) on behalf of the patient, and then present the partially or completed patient information form(s) with the patient answers in the appropriate entry areas appearing on the form(s), for the patient's review and/or editing. This greatly simplifies the amount of effort required from the patient, particularly when dealing with multiple sets of forms from multiple practice groups. Following patient approval, the completed or partially completed forms can be saved for future use/updates by the patient and/or sent to the relevant practice group(s).

These and other features of the present invention will be described in various embodiments below.

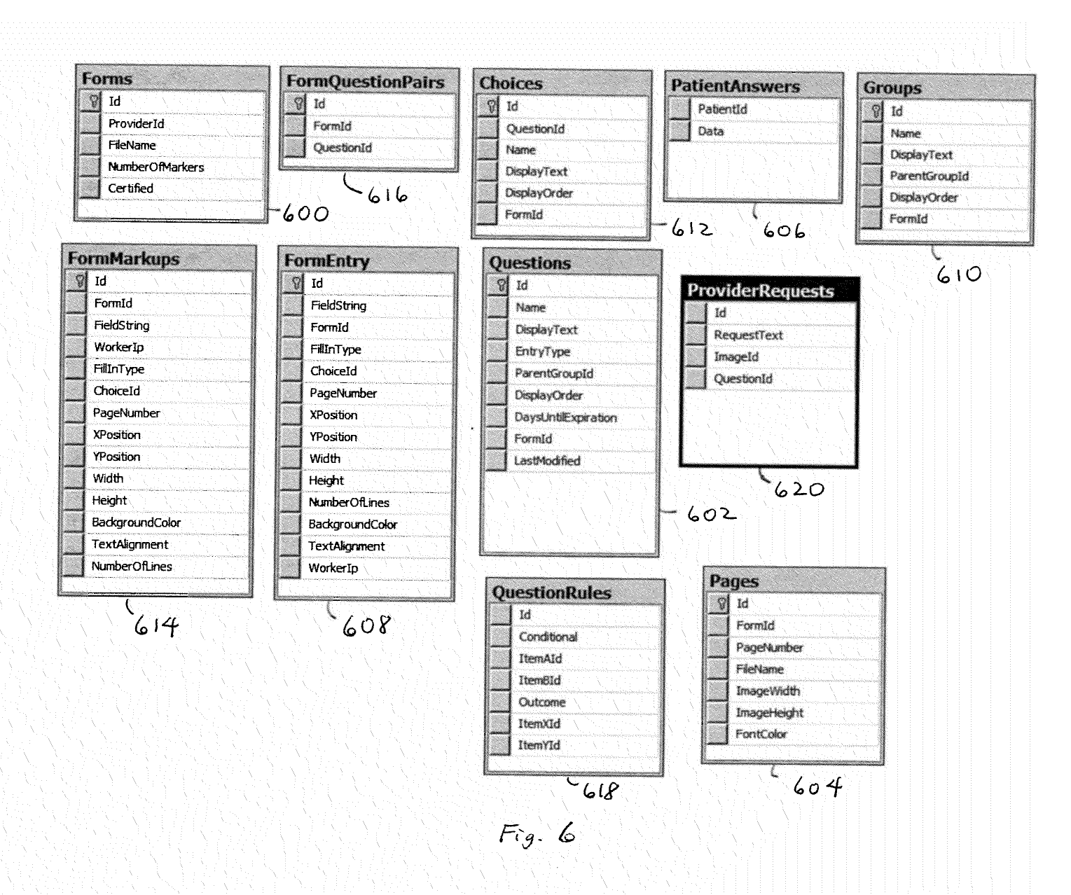

The following examples illustrate the aggregator's utilization of the data and metadata in a relational database (e.g., FIG. 6) for generating marked-up forms, creating a library of questions, associating questions to the entry areas of the marked-up forms, establishing relationships between questions, and soliciting patient information with ordered sets of questions to reduce the time required by the patient to provide the necessary information and facilitating the use of such information across patient information forms for multiple practice groups.

B. Question Rules

The following are examples of question rules:

The above rules are provided by way of example only and are not meant to limit the invention.
C. Creation of Marked-up Patient Information Forms

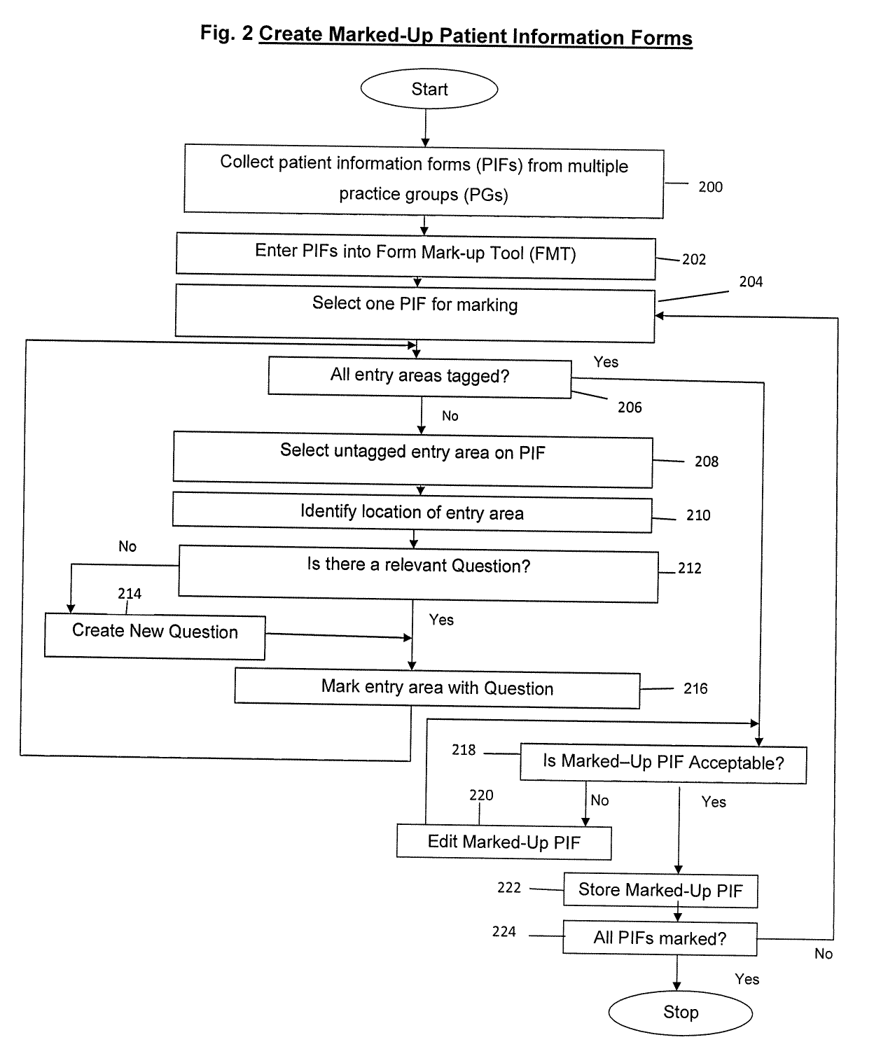

Referring now to FIG. 2 there is illustrated a flow chart of a process for creating marked-up patient information forms according to one embodiment of the invention. At 200, the aggregator collects patient information forms (PIFs) from multiple practice groups (PGs). The aggregator may collect hundreds or even thousands of different patient information forms from different practice groups. In one embodiment, the aggregator provides a web-based service enabling the practice groups to upload their forms to the aggregator's server. The forms are then loaded into the aggregator's form mark-up tool (FMT) on the aggregator's server, enabling the aggregator's employees to view (on a computer screen) an image of each PIF and create a marked-up form for each individual PIF. In one example, the forms are received in pdf (portable document format) and the aggregator translates the pdf form to jpeg (joint photographic experts group) form enabling the employees utilizing the marking tool to select (visually identify) physical locations on each form page corresponding to entry areas that request patient information. In another embodiment, the aggregator may receive the forms from the practice groups by mail, and may scan them for entry into the mark-up tool.

Returning to FIG. 2, at 202 the PIFs are entered into the form mark-up tool (204) and one PIF is selected for marking (step 204) and displayed to a user (human operator) (e.g., as shown in FIG. 8A). The user visually scans the page to identify entry areas to be tagged (marked) at step 206. The user selects an untagged entry area on the PIF at step 208. At 210, the user identifies the location of the entry area, e.g., its X and Y coordinates on the page with respect to a fixed reference point, such as the lower left corner of the page. At 212, the user determines whether there is a relevant question in the question library for associating with (mapping to) the request in the respective entry area. If there is a relevant question in the library, at 216 the user marks (associates) the entry area with the question. For example, in the database schema of FIG. 6 a FormQuestionPairs table 616 associates a QuestionId (question in the aggregator's question library) and FormId (a marked-up provider form). A ProviderRequests table 620 associates a ProviderRequest ID (one request for patient information on the provider's form) with a QuestionID (one question in the Questions table 602); typically, there will be many different ProviderRequests that map to a single Question (e.g., multiple variations of requests in the PIFs asking for patient address, which map to one common Question asking for patient address information in the QuestionsLibrary). A FormEntry table 608 includes the FormId, PageNumber and location fields (e.g., XPosition, YPosition, Width, Height) for associating a particular entry area in a marked-up form (FormId) with a particular form-question pair. If there is no relevant question in the library (e.g., Questions table 602 in FIG. 6), at 214 the user can create a new question for this entry area (e.g., see the AddFormQuestion button 812 in FIG. 8A and the “Create Questions” page of FIG. 8B). Once the user has associated a question with the entry area, the process returns to step 206 to determine whether additional entry areas need to be completed (marked). Once all entry areas are completed, at step 218 the user reviews a marked-up PIF to determine if the markings are acceptable (see e.g., the user interface of FIG. 8C). If acceptable, the user stores the marked-up form at step 222, for example, on the aggregator's server. Alternatively, the user can now edit the marked-up form at step 220, prior to accepting the form at 218. After storing the marked-up form, the process determines whether all PIFs have been marked at step 224. If yes, the process ends; if no the process continues by selecting the next PIF for marking at step 202.

C. Populating Patient Information Forms

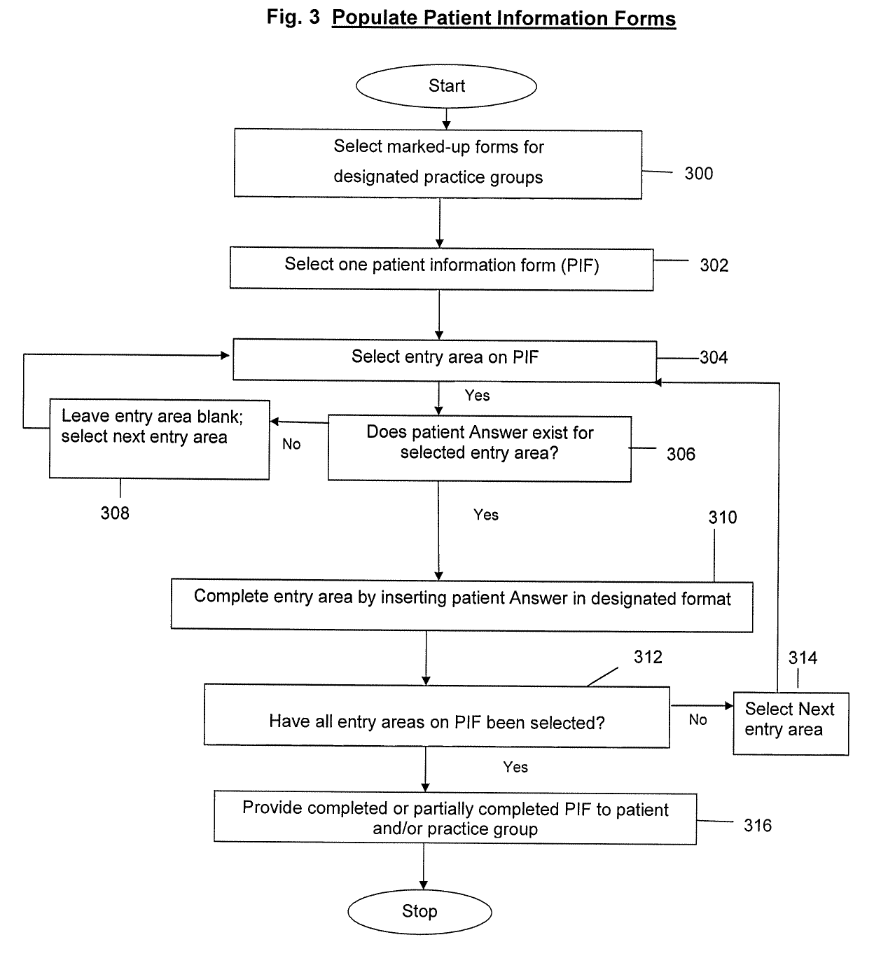

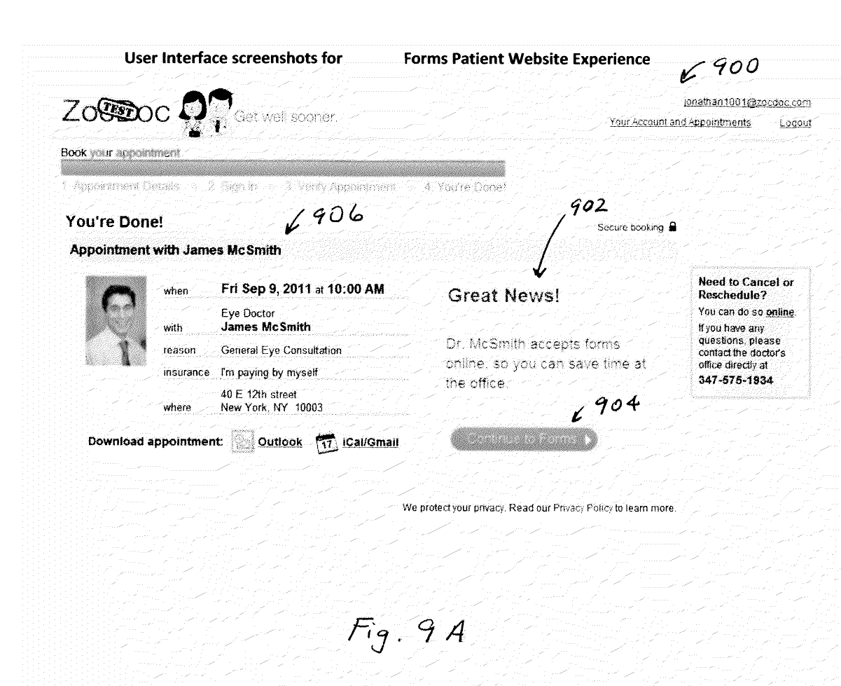

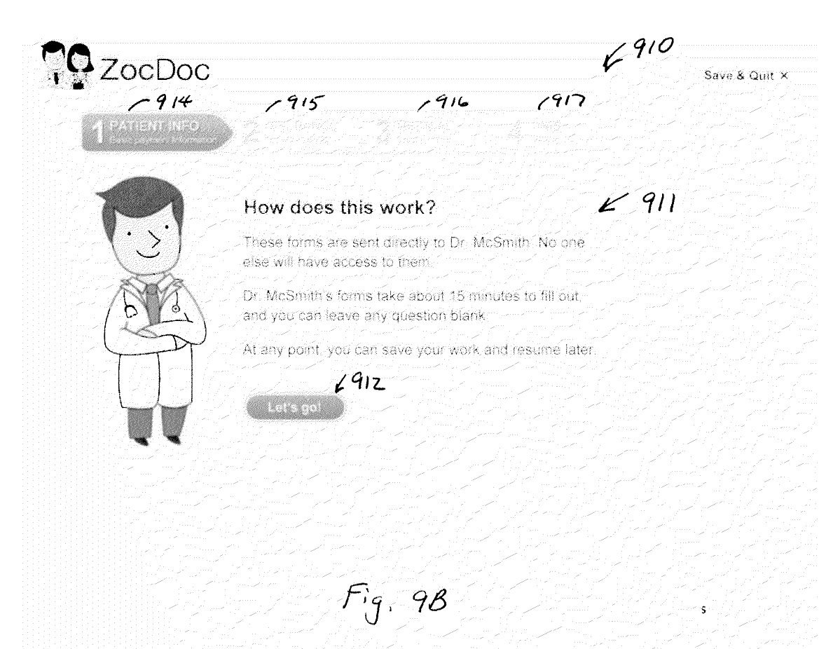

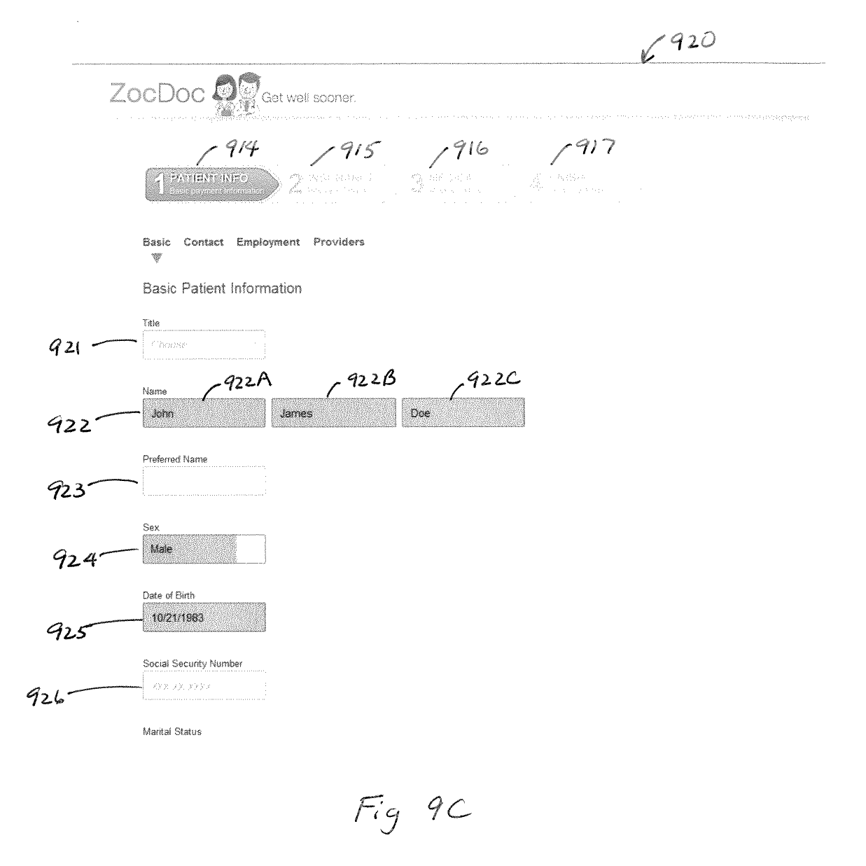

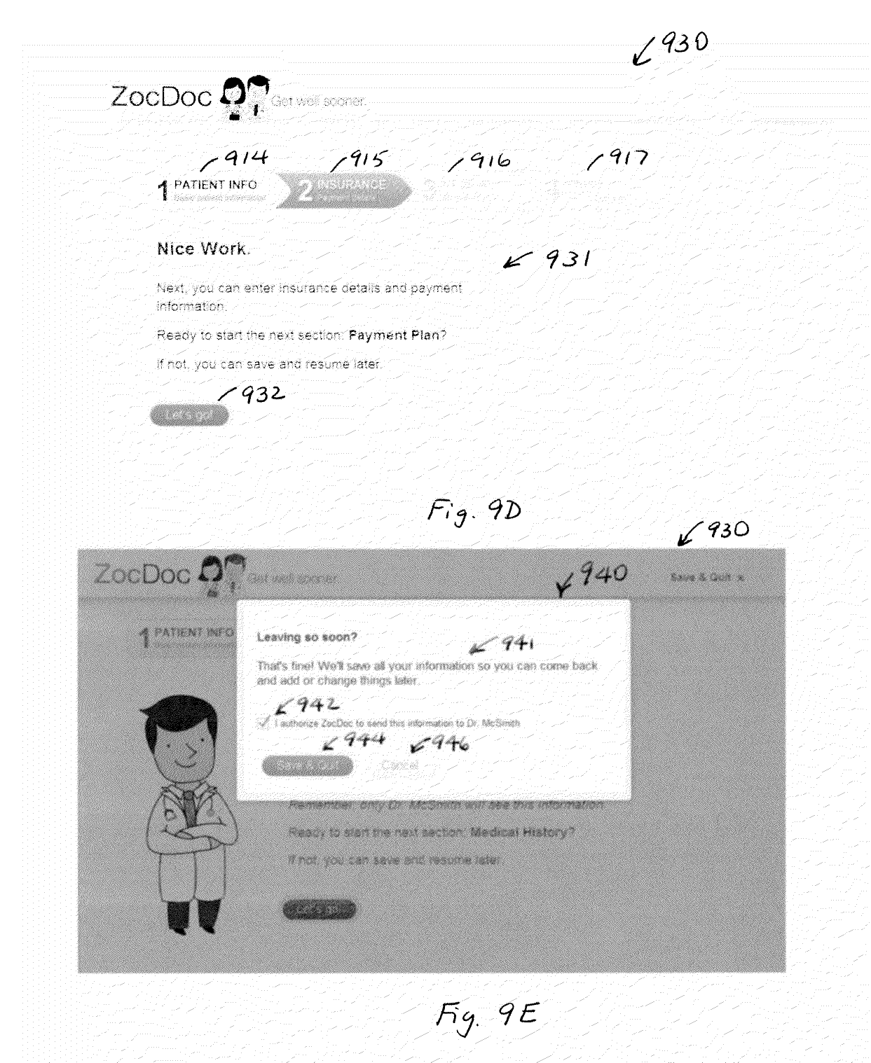

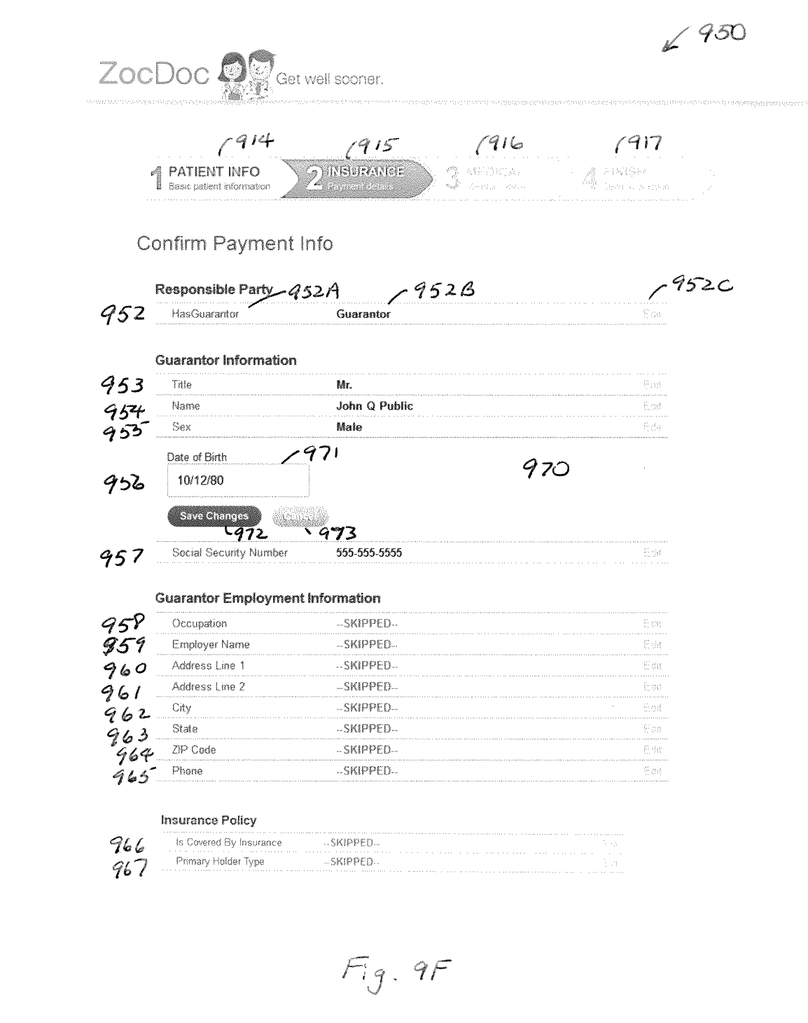

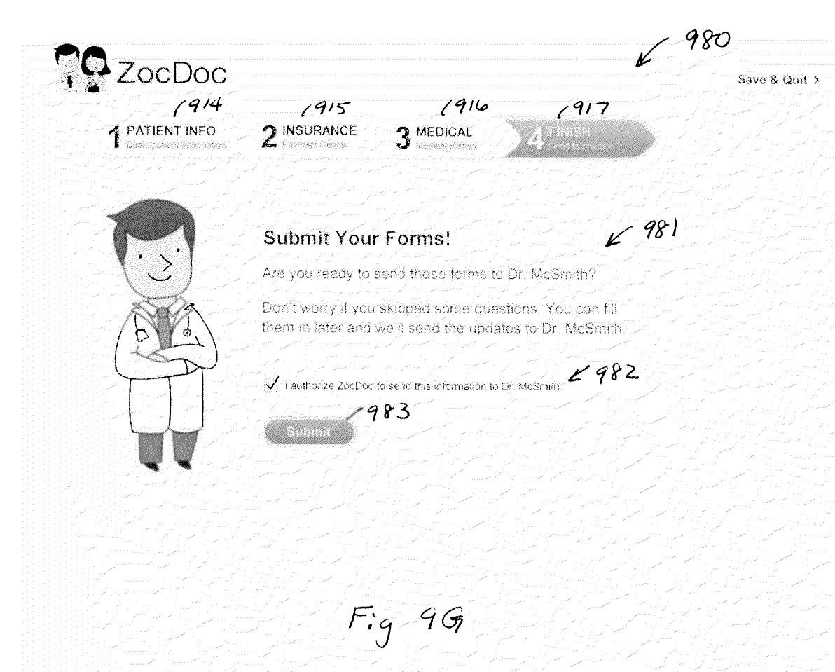

Referring now to FIG. 3, there is illustrated a flow chart of a process for populating patient information forms according to one embodiment of the invention. At 300, a marked-up form is selected for a designated practice group. As illustrated in step 222 of FIG. 2, the marked-up forms may be stored in the aggregator server, wherein each marked-up form is tagged with a practice group identifier (e.g., FormId, and ProviderId, as illustrated in FIG. 6). The process of FIG. 3 may begin for example by asking a patient who has just booked an appointment (e.g., see FIG. 9A) if he/she would like to begin the form filling out process for the booked appointment. At 302, one patient information form (e.g., for the upcoming appointment) is selected, and an entry area on that PIF is selected at step 304. At 306 it is determined whether a patient answer already exists for the selected entry area (e.g., see the PatientAnswers table 606 in FIG. 6 wherein all of the patient answers are encrypted into the Data field; when the data field is decrypted, each patient answer is associated with a question in the Questions table 602). If a patient answer exists for this entry area, it is inserted into the entry area in a format appropriate for the entry area at 310 (see e.g., in FIG. 6 the FillInType in the FormEntry table 608). If there is no existing answer, then at step 308 the entry area is left blank and the next entry area is selected (step 304) and the process continues at step 306. At 312, it is determined whether all entry areas of the marked-up PIF have been selected to determine if a patient answer exists. If not, the process proceeds to select the next entry area at step 304. If all entry areas have been selected, then the process proceeds to step 316 in which the completed or partially completed PIF is shown/sent to the patient for viewing and/or editing, and/or requesting the patient's approval prior to sending the fully or partially populated PIF to the designated practice group.

D. Completing Patient Information Forms

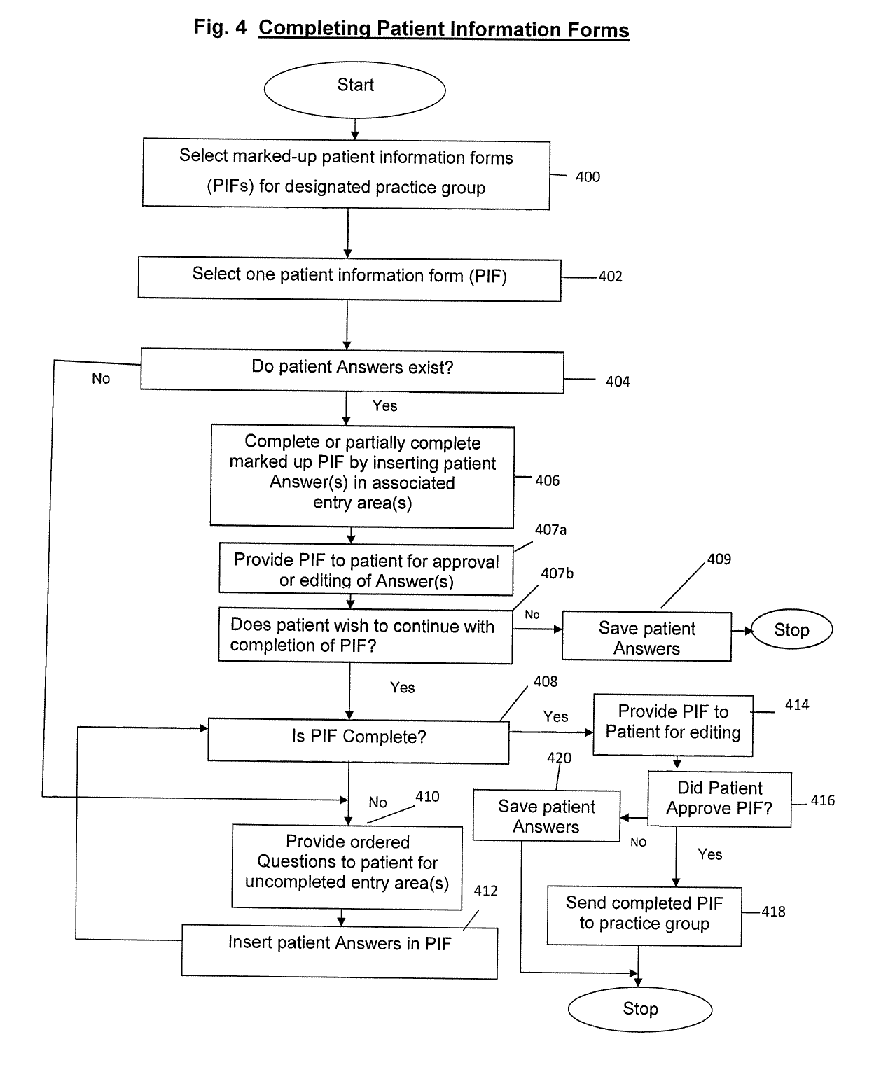

Referring now to FIG. 4, there is illustrated a flow chart of a process for soliciting information from patients for completing patient information form(s). At 400, one or more marked-up patient information forms (PIFs) are selected for a designated practice group. Similar to FIG. 3, one PIF is selected (step 402) and it is determined whether patient answer(s) exist for the one or more entry areas of the selected PIF (step 404). If a patient answer exists (e.g., see the PatientAnswers table 606 of FIG. 6), the answer is inserted into the associated entry area of the marked-up PIF (step 406). At 407a, the patient is shown the completed or partially completed PIF to edit and/or approve the Answer(s). At 407b, the patient is given the option to continue, or alternatively to resume the process later; if he/she decides to resume later, the patient answers will be saved (step 409) and when the patient logs back in the form will continue where the patient left off. Assuming the patient continues, at 408, the PIF is reviewed to determine whether it is now complete, meaning all patient answers have been entered. If not, then a set of ordered questions is transmitted to the patient seeking responses for uncompleted entry areas (step 410). If the patient provides answers, the answers (after proper formatting) are inserted in the associated entry areas of the PIF at step 412. The process returns to step 408 to determine if the PIF marked-up form is complete. If it is, the process proceeds to step 414 by providing the form with the patient's answers to the patient for review and/or editing. At 416, the patient is asked to approve the PIF; if approved, the completed PIF can be sent to the practice group (step 418) and the process ends. If the patient does not approve the PIF, then the patient's answers can be saved (e.g., on the aggregator server) at step 420 and the process ends.

E. Requesting Patient Information

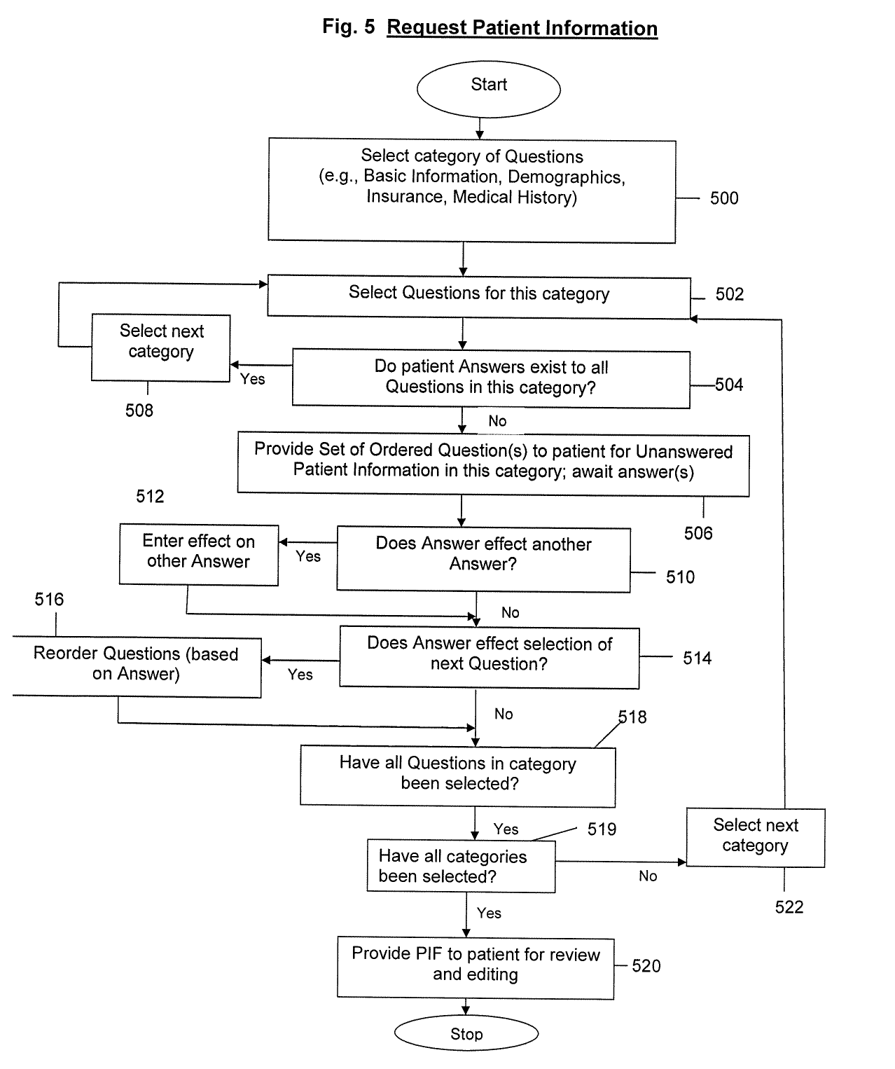

Referring now to FIG. 5, there is illustrated a flow chart of a process for requesting patient information. In this example, the patient response to a question may affect (change) another answer or question or the order of questions presented. At 500, a category of questions is selected, (e.g., based on the subject matter of the desired patient information, such as basic information, demographics, insurance, medical history—see for example the categories and subcategories of questions illustrated in FIG. 8B). Next, at 502, the questions for this category are selected and it is determined (step 504) whether patient answers to all questions already exist (e.g., in the PatientAnswers table 606). If yes, the process selects the next category at step 508 and proceeds at step 502. If patient answer(s) do not exist for one or more questions in this category, at step 506 a set of ordered question(s) is presented to the patient (see e.g., the Groups table 610 in FIG. 6 which includes a ParentGroupID (identifies a category or subcategory) and DisplayOrder (order of questions within the group). The process awaits each patient response. After each patient response, at 510 it is determined whether the patient's answer affects another answer in the library of answers. The question rules determine whether one answer affects another answer (see e.g., QuestionRules table 618 in FIG. 6 and the examples in FIG. 8B). If another answer if affected, at 512 the process enters the affect on the other answer and returns to step 514. If the answer does not affect another answer, then the process also continues to step 514 and determines whether the answer affects the selection of the next question. For example, in FIG. 6 the QuestionRules table 608 has an Outcome field to allow reordering of questions based upon a particular patient response received to a question in the set for a given category. If the answer affects another question, then at 516 the process adds new questions, deletes questions and/or reorders the questions and proceeds to ask the new set of ordered questions. Once all of the questions in the category have been selected (step 518), it is determined whether all categories have been selected (step 519); if not the next category is selected (step 522) and the process adds new questions and/or resumes at step 502. Once all categories have been selected, the answers are inserted into the PIF and is presented to the patient for review and/or editing at step 520 and the process ends.

F. Database Schema for Patient Forms

FIG. 6 illustrates one embodiment of relational database architecture for storing data and metadata relating to the gathering of patient information, the creation of marked-up forms, and the completion of patient information forms. In this example, eleven database tables are provided:
Forms 600, Questions 602, Pages 604, PatientAnswers 606, FormEntry 608, Groups 610, Choices 612, FormMarkups 614, FormQuestionPairs 616, QuestionsRules 618 and ProviderRequests 620.

Each table has a key field containing an identifier for a particular instance of the respective form, question, answer, etc. Each table includes multiple fields for storing data or metadata relating to the patient information and the process of creating marked-up forms and completing the forms for the purposes previously described. Use of this database in various embodiments of the invention is described throughout the specification. The database schema of FIG. 6 is only one example of a suitable database; other tables, fields and relationships can be used, as well as other types of databases, e.g. object database structures. The invention is not limited to any particular database structure or organization.

G. Mark-Up Tool

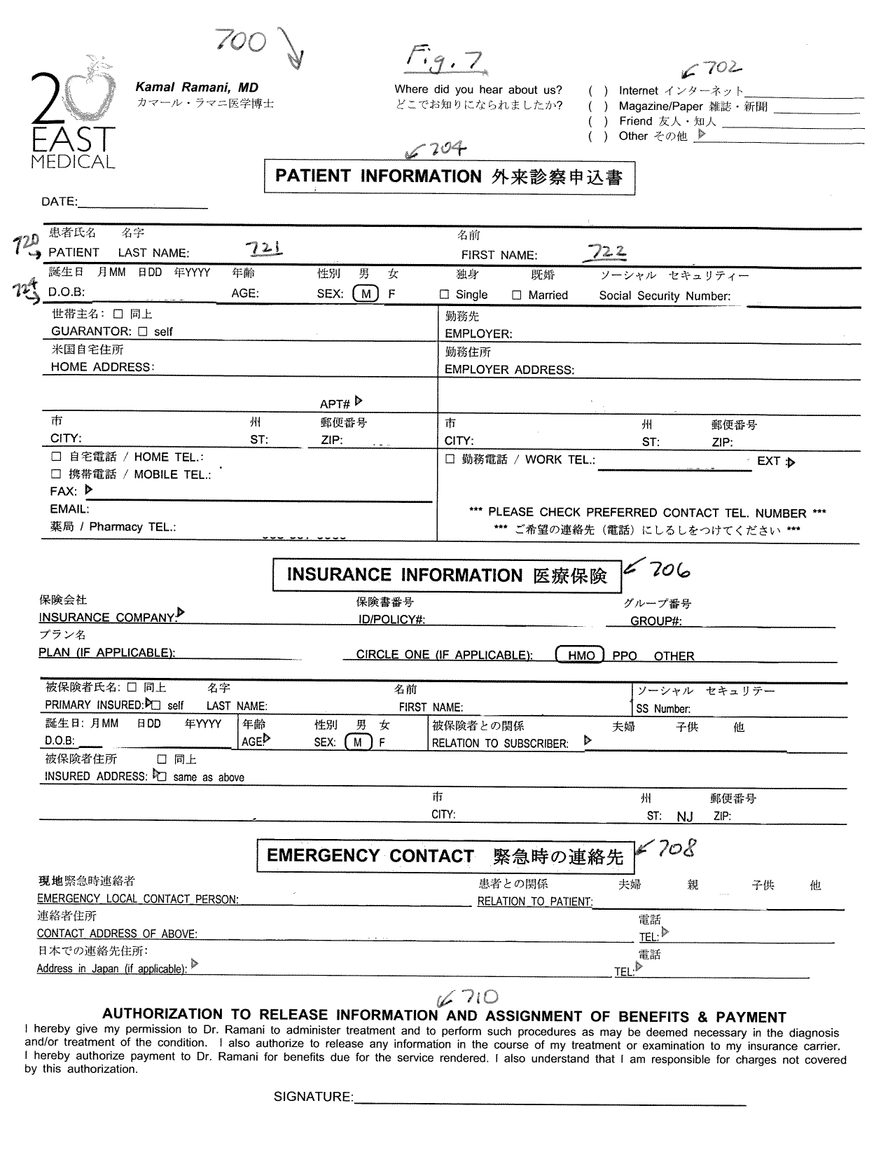

A more particular implementation of a mark-up tool of the invention will now be described with respect to FIGS. 7-8.

FIG. 7 illustrates one example of a patient information from 700 for a particular practice group. This one page form requests various categories of patient information including: referral information 702 (asking the patient where they learned of the practice group); patient information 704; insurance information 706; emergency contact 708; and authorization and assignment information 710. As discussed further below with respect to FIGS. 8A-8C, the locations of the various entry areas requesting patient information, are used in the process of the invention to create marked-up forms. Here, the referral information section 702 is located in the upper right hand corner of the form; it includes one question followed by four check boxes, each check box having separate text designating a different response, and each text being followed by a blank (underline) in which the patient can insert free text as a further explanation of the answer. Below this, the patient information section 704 spans the width of the page and includes multiple entry areas requesting different types of information. Some entry areas request multiple related parts of the complete answer. For example, the first bounded area 720 under patient information asks for the patient's name, and includes two separate entry areas for entering the patient's last name 721 and first name 722. The next bounded area 724 requests date of birth, age, sex, marital status and social security number; it includes blank entry areas for each of these and seeks patient responses in different formats, e.g., free text, a single select set of alternatives that can be circled, and a single select set of alternatives with check boxes. Also, in this example, the form is written in both English and Chinese and there are separate areas for responses provided in each language. Again this is one example of the many types of different forms used by different practice groups, each containing different categories of requested information in formats unique to each individual form.

As previously described, it is expected that multiple practice groups will upload multiple forms to an aggregator server which forms are then entered into the aggregator's form mark-up tool. FIGS. 8A-8C illustrates one example of a tool (application) and process of using the same. FIG. 8A shows on a computer display screen 802 a scanned image of a one page patient information form 800. A human operator can visually review the form on the screen and identify (select via e.g., a keyboard or mouse) the locations of the individual entry areas 804, 806, 808 for the process of creating a marked-up form. Here, a first entry area 804 of the form 800 requests the patient's name, and there is shown a tag or marker 820 in this entry area which associates the entry area with a question (relevant to patient name) from the aggregator's question library. If the form 800 includes a question that does not have an appropriate counterpart in the question library, a new question can be added to the aggregator's question library utilizing the interface 830 shown in FIG. 8B. Here, the administrator has selected the subcategory Name 831, under parent categories Basic Information 832 and Registration Forms 844, respectively, for the purpose of adding a new question relating to patient name to the library. Once added to the library, this question can then be used for marking up other forms as well.

In this example, two users independently undertake the marking process to create two versions of a marked-up (tagged) form. FIG. 8C shows the two marked-up versions 872, 874 presented for side-by-side comparison on the aggregator's mark-up review utility screen 870. The same or different users can then review the two proposed marked-up forms 872, 874 and edit one or both of those forms accordingly and ultimately choose one final marked-up form for storage and/or future use.

Other more specific features of the mark-up tool application shown in FIGS. 8A-8C will now be described. In FIG. 8 to the left of the form 800 undergoing review, there is shown a first entry box 810 which prompts the human operator to select an appropriate question from the aggregator's questions library. For example, if the operator types in the word “address” in box 810, one or more names of potentially applicable questions (relating to patient address information) from the questions library will appear, from which the operator can then select. Here, the operator has selected the question name “patient addresses 1”. Having made this selection, the tag <patient address 1> appears in the next box 811; the operator can drag the tag over onto the appropriate entry area on the form 800, here the entry area 808. If the operator does not see an appropriate question in the questions library, the operator can click the button 812 entitled Add Form Questions, to create a new question for the questions library. Alternatively, if no question is applicable and the operator prefers to allow the patient to fill in this entry area on the printed form, the operator clicks the button 813 entitled “Unknown Field” which will put an indicator (e.g. arrow) on the printed partially populated form prompting the patient to write in his/her answer on the form.

FIG. 8A also shows a window 814 with three links labeled “Registration Forms”, “Medical History Forms”, and “New Tree”, from which the user can select to navigate the hierarchy of library questions (see 840 in FIG. 8B discussed below) to find an appropriate question in the questions library. However, such a manual review of the existing questions in the library may be more time consuming than the operator simply entering one or more words from the provider request in box 810 whereby the application selects and presents the potentially relevant questions from the library relating to the entered word(s).

Because a patient information form may include multiple pages, the interface of FIG. 8A includes buttons below the illustrated page 800 of the form, for moving between the different pages (e.g., Previous Page 815, Next Page 816), as well as buttons for calibrating the font size 817 and previewing the entire form 818. To the right of the illustrated form 800, the interface includes a window 819 which identifies the entry area that is currently highlighted on the form being marked.

The user (e.g., administrator) interface of FIG. 8B includes a central window 834 and a series of navigation tabs across the top for selecting different functions of the tool. In addition to a home page tab 835, these tabs select functions such as “Create Questions” 836, “Mark-up Forms” 837, “Validate Forms” 838, and “View Forms” 839. In the central window 834 there is shown a hierarchical (tree) organization or index 840 of the questions library. Under the top level designation Patient Information 841 there are categories: New Tree 842, Medical History Forms 843, and Registration Forms 844. Eight subcategories are listed under the Medical History Forms (parent category) 843. Numerous subcategories are listed under the Registration Forms (parent category) 844. The subcategory Basic Information 832 includes further subcategories, wherein the subcategory Name 831 is shown selected by the user for the purpose of the adding or modifying the Name category.

To the right of the organization tree shown in FIG. 8B, there is provided an area 850 for the user to create question rules that establish relationships between questions and answers. The rules created are based on choices (alternatives) by which the answer to one question effects either or both another answer or the order of questions. In this example, a first box 851 contains the text “If question A is choice B”, as a first item on a pull down menu. Below this box are the two choices, Item A 852 and Item B 853. In a next entry box 854 is the text “Ask question X”, as the first item of a pull down menu. Below this entry box are the Items X and Y 855, 856. An add button 857 is clicked to enter the new rule in the database. An editing box 858 appears below the two entry boxes for facilitating creation of a new question and relationships. Two examples are shown in window 858. In the first example 860, if question A is “Employment”, and choice B is “Student: Full-time”, then next ordered question X is “Patient Occupation”. In the next example 861, question A is an alternative item on the pull down menu for establishing an inheritance relationship. Here, if question A is “Ok to leave message?” and choice B is “Cell Phone”, then the patient answer “Acceptable-to-leave-message Cell Phone” is set to the answer of “Cell Phone Number”.

H. Collecting Patient Information

Another aspect of the invention concerns the collection of patient information for use in completing the marked-up forms. FIGS. 9A-9G illustrate screenshots of an interactive patient website experience for submission of patient information. In this embodiment, the aggregator provides an online service which remote users can access using a computer or other portable wired/wireless device (e.g., cell phones) for booking via the Internet online medical appointments with a plurality of practice groups. FIG. 9A is a screenshot 900 of the aggregator's web-based service, showing that the patient has just booked an appointment with eye doctor James McSmith for a general eye consultation (see booking Confirmation 906). The webpage now prompts the patient (via text 902) to submit patient information by notifying the patient that Dr. McSmith accepts forms online and providing a button 904 to begin the process entitled “Continue to Forms”. If the patient accepts by clicking the button, a series of webpages illustrated in FIGS. 9B-9G are provided to the patient in serial order to guide the patient through the submission process. The four steps of the process are designated in tabs entitled: “1 Patient Info” 914, “2 Insurance” 915, “3 Medical” 916, and “4 Finish” 917 across the top of the page 910. FIG. 9B shows a first page 910 in the four step process entitled “Patient Info, Basic Payment Information” and provides text 911 informing the patient that the forms will be sent directly to Dr. McSmith and could take about 15 minutes to fill out. However, if the patient stops at any point the entered information can be saved and the process resumed later. Assuming the patient accepts, he/she clicks a button 912 entitled “Let's Go!”, and proceeds to the next webpage 920 illustrated in FIG. 9C. Here, the aggregator provides a series of ordered questions 921-926 for soliciting information in the category of basic patient information; the questions are chosen from the aggregator's library of questions and are presented as text entry boxes 921-926 for completion by the patient. Here, the boxes include the patient's title 921, for selection from a drop down menu, text boxes for entering the patient's first 922A, middle 922B, and last name 922C separately, a text box 923 for entering a preferred name, a multi-selection question 924 on sex for which the patient selects from a drop down menu, a text box 925 for entering a date of birth, a text box for entering social security number, etc. The aggregator presents the questions on the webpage in an order and form that will facilitate utilization of the patient responses across multiple different practice forms, namely by associating the aggregator's questions with particular entry areas on the different marked-up patient information forms and providing rules governing the relationships between the aggregator's questions and/or patient answers For example, rather than providing one question (entry box) asking for the patient's entire name, the aggregator provides three entry boxes 922A, 922B, 922C asking for the patients first, middle and last name respectively in separate boxes so that the data can be separately stored and used across multiple patient information forms that may require one, two, three or all three components of the patient's response. Following the patient's review and response(s) to the basic patient information questions, during which the patient may complete all, a portion, or none of the questions, the patient is then prompted via text 931 in a next webpage 930 (FIG. 9D) to continue to the next step asking for insurance details and payment information by clicking the button 932 entitled “Let's Go!” Alternatively, if the patient declines, a window 940 (see FIG. 9E) is superimposed on the webpage 930 of FIG. 9D with text 941 informing the patient that the information entered will be saved and the patient can resume later. Further a check box 942 is provided prompting the patient to authorize the aggregator to send the partial information provided to Dr. McSmith by clicking the button 944 entitled “Save & Quit”. Alternatively, the patient can hit the button 946 entitled “Cancel” and the information will not be saved nor sent to Dr. McSmith. Assuming the patient clicks the button 932 “Let's Go!” in FIG. 9D, the insurance payment information appears in the user interface on a next webpage 950 shown in FIG. 9F.

Again, an ordered set of questions 952-967 are provided on the webpage by the aggregator soliciting patient responses that can be used across a plurality of patient information forms. In this example, some of the information is already entered based on information previously provided by the patient to the aggregator, for example during patient registration for the aggregator's online booking service. Each question line (e.g., first line 952) has a question space 952A, an answer space 952B, and an edit button 952C enabling the patient to change the previously provided information and/or enter new information. If the patient clicks on an edit icon, e.g., in line 956 where the question asks for “Date of Birth” 956A, a window 970 appears with an entry box 971 for entering the new or modified information (date of birth) and buttons 972, 973 are provided for saving the changes or canceling the changes, respectively.

A similar third step of the process (not shown) is a webpage providing a set of ordered questions related to the category of patient medical history. At the end of each section category (i.e., 914, 915, 916) there is a confirmation page that allows the patient to review all of the information he/she has entered and edit the information. Once all three sections are completed, a finish webpage 980 (FIG. 9G) is presented in the user interface. The patient is prompted via text 981 and check box 982 to submit the forms to Dr. McSmith by clicking on the Submit Button 983. The aggregator will populate the marked-up forms associated with Dr. McSmith for the scheduled appointment, with the patient responses (from the process of FIGS. 9C-9G) and send the fully or partially forms to Dr. McSmith (e.g., via email or by posting on an aggregator online service accessible to Dr. McSmith's practice group).

I. Network Communications and Computing Environment

The previously described methods may be implemented in a suitable computing environment, e.g., in the context of computer-executable instructions that may run on one or more computers. In for example a distributed computing environment certain tasks are performed by remote processing devices that are linked through a communications network and program modules may be located in both local and remote memory storage devices. The communications network may include a global area network, e.g., the Internet, a local area network, a wide area network or other computer network. It will be appreciated that the network connections shown herein are exemplary and other means of establishing communications between the computers may be used.

A computer may include a processing unit, a system memory, and system bus, wherein the system bus couples the system components including, but not limited to, the system memory and the processing unit. A computer may further include disk drives and interfaces to external components. A variety of computer-readable media can be accessed by the computer and includes both volatile and nonvolatile media, removable and nonremovable media. A computer may include various user interface devices including a display screen, touch screen, keyboard or mouse.

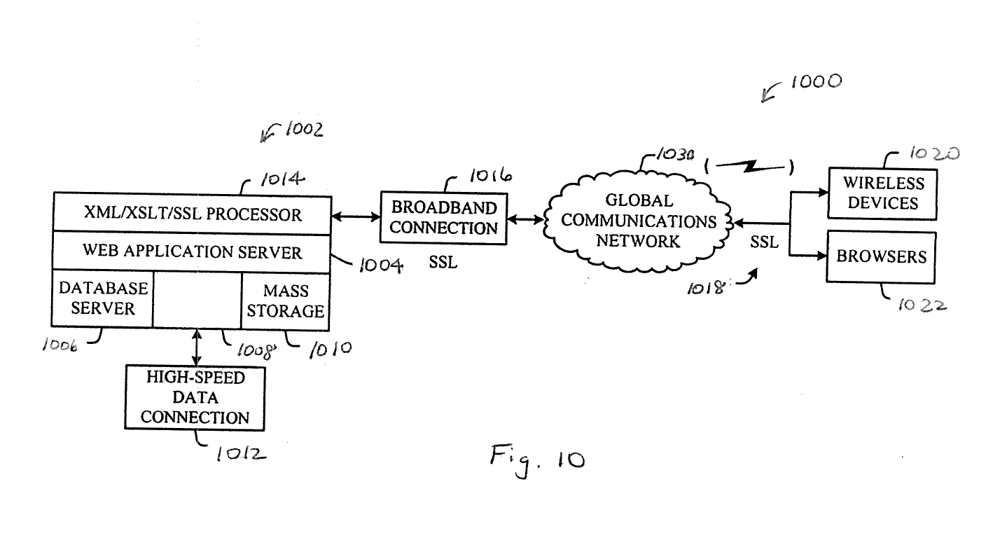

Referring now to FIG. 10, there is illustrated a general system configuration for communications between the patients and the aggregator, and between the practice groups and the aggregator. In one embodiment, the system 1000 includes an aggregator's platform 1002 that hosts at least a data management tool, here a web application server 1004. The server 1004 provides a common layer to underlying services that include a database server 1006, a mass storage 1010, and an interface 1008 to a high-speed data connection 1012 (e.g., T1, DS3) to accommodate processing, storage and/or communications with remote locations and/or users (e.g., patients, practice groups) from virtually any accessible network node. Further, the platform 1002 can include a processor 1014 suitable for XML (extensible Mark-up Language), XSLT (XML Stylesheet Language, Transformations), and SSL (Secure Sockets Layer) processing. The processor 1014 can also access web based services utilizing SOAP (Simple Object Access Protocol). There is a high speed connection 1016 (e.g., broadband) that interfaces to the processor layer 1014 for multiple communication exchanges with remote users disposed on a global communications network 1030 (e.g., Internet). The remote users can access the platform 1002 via an SSL connection 1018 using portable wired/wireless devices 1020, or by way of the associated browsers 1022, or other applications.

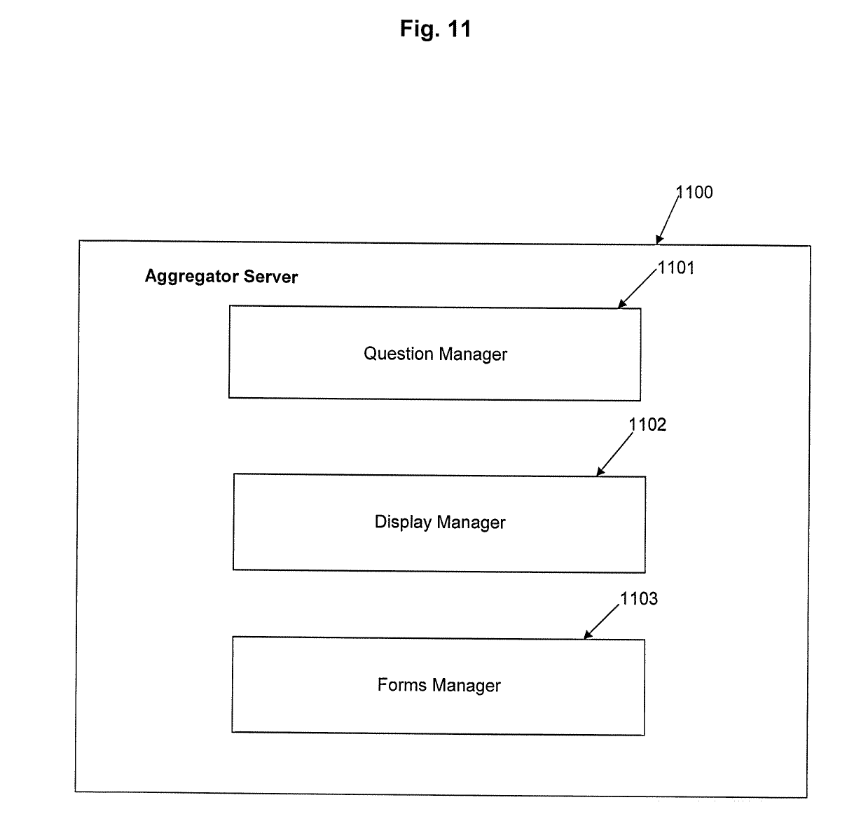

FIG. 11 shows one embodiment of an apparatus for implementing the present invention. An aggregator server 1100 includes a question manager component 1101 operable to generate an ordered set of questions from a stored library of patient information questions. The question manager includes a rule based logic for determining a presentation order of the questions in the set. The server further includes a display manager component 1102 operable to present the ordered set of questions to a patient and solicit responses to the questions from the patient. The server may further include a forms manager component 1103 operable to generate marked-up patient information forms for each of the plurality of practice groups, each marked-up form having one or more entry areas each having an associated question from the library of questions, and for populating the entry area(s) of the patient information form with the patient response(s).

What has been described above includes examples of the present invention. It is, of course, not possible to describe every conceivable combination of components or methodologies for purposes of describing the present invention, but one of the ordinary skill in the art will recognize that further combinations and permutations of the present invention are possible. Accordingly, the present invention is intended to embrace all such alternations, modifications and variations that fall within the present disclosure and/or claims.

1. A computer-implemented method comprising:
storing a plurality of marked-up patient information forms (PIFs) for a plurality of different practice groups, each marked-up PIF having a plurality of entry areas requesting patient information and each entry area having a question identifier of an associated question from a stored library of patient information questions;
displaying to a patient an ordered set of associated questions from the library for a marked-up PIF and soliciting responses from the patient to the questions; and
receiving one or more responses from the patient to the questions and associating each response with an entry area of the marked-up PIF.

2. The method of claim 1, further comprising:
generating a partially or fully populated PIF from one of the marked-up PIFs by inserting the one or more patient responses in the entry area(s) having the associated question identifier(s).

3. The method of claim 2, further comprising:
displaying to the patient a partially or fully populated PIF for editing and/or approval.

4. The method of claim 2, further comprising:
sending the partially or fully populated PIF to one or more of the practice groups.

5. The method of claim 1, wherein:
the displaying step occurs after the patient has booked an appointment with the practice group.

6. The method of claim 1, wherein:
the questions include relationships between the questions.

7. The method of claim 6, wherein:
the relationships include a hierarchical relationship.

8. The method of claim 7, wherein:
the hierarchical relationship includes categories of patient information.

9. The method of claim 8, wherein:
the categories include one or more of medical history information, insurance information, basic information, demographic information, contact information, and family information.

10. The method of claim 1, further comprising:
generating the ordered set of questions using a rules set for determining a presentation order of the associated questions in the set.

11. The method of claim 10, wherein:
the rules set includes one or more of question expiration, question succession, question inheritance, question duplication, question concatenation, and question omission.

12. The method of claim 1, further comprising:
generating the marked-up PIFs by displaying a visual image of a patient information form to a human operator and soliciting from the operator the question identifier for the entry area on the patient information form.

13. The method of claim 1, further comprising:
generating the marked-up PIFs with a computer program application which designates the question identifier for the entry area.

14. The method of claim 1, further comprising:
collecting a plurality of patient information forms from the different practice groups;
generating the plurality of marked-up patient information forms for the collected forms, including designating the question identifier for the entry area.

15. A computer-implemented method comprising, for each of a plurality of patient information forms (PIFs) from a plurality of practice groups:
identifying each entry area of the PIF that requests a patient answer;
associating each entry area with:
a location identifier defining a physical location of the entry area on the PIF;
a question identifier of an associated question from a library of questions for soliciting patient information applicable to the plurality of PIFs from the plurality of practice groups.

16. The method of claim 15, further comprising:
displaying to a patient an ordered set of associated questions from the library for a PIF and soliciting responses from the patient to the questions.

17. The method of claim 16, further comprising:
receiving one or more responses from the patient to the questions and associating each response with a location identifier.

18. Computer-readable medium having stored thereon instructions which perform, when loaded into a computer, the steps of:
selecting a category of patient information;
selecting a set of ordered questions, related to the category, from a library of questions for soliciting patient information applicable to one or more of a plurality of patient information forms (PIFs) from a plurality of practice groups;
presenting the set of ordered questions to a patient;
receiving from the patient one or more responses to the questions presented;
associating each response with at least one of the questions presented.

19. In a computing environment, an apparatus comprising:
a question manager component operable to generate an ordered set of questions from a stored library of patient information questions, the question manager including a rule based logic for determining a presentation order of the questions in the set; and
a display manager component operable to present the ordered set of questions to a patient and solicit responses to the questions from the patient.

20. The apparatus of claim 19, further comprising:
a forms manager component operable to generate marked-up patient information forms for each of a plurality of practice groups, each marked-up form having one or more entry areas, each entry area having an associated question from the library of questions, and for populating the entry area of the patient information form with a patient response.
